(19) United States
(12) Patent Application Publication
(10) Pub. No.: US 2013/0076182 A1
(43) Pub. Date: Mar. 28, 2013

(54) Non-polluting electric generator

(71) Applicant: Stephane Mercier, St-Jean-Sur-Richelieu (CA)

(72) Inventor: Stephane Mercier, St-Jean-Sur-Richelieu (CA)

(21) Appl. No.: 13/621,259

(22) Filed: Sep. 16, 2012

(30) Foreign Application Priority Data
Sep. 16, 2011 (GB) 1116097.5

(51) Int. Cl. H02K 47/04

(52) U.S. Cl. CPC H02K 47/04
USPC 310/113

(57) ABSTRACT

A non-polluting electric generator having at least one battery, an electric motor connected to the battery by electric wires, an alternator, a belt member connected between the alternator and the electric motor, and electric wires extending from the alternator adapted to connect with an electric appliance, such that the generator uses the stored energy of the battery to run the electric motor, which then runs the alternator, which then sends the desired electricity to an electric appliance.

This application claims priority based on request GB1116097.5 filed Sep. 16, 2011.

### FIELD OF THE INVENTION

The present invention relates generally to electrical generator but more particularly to a generator using a battery.

### BACKGROUND OF THE INVENTION

There are many types of generators that are used for emergency purposes or for areas where no electricity is available.

### SUMMARY OF THE INVENTION

In view of the foregoing disadvantages inherent in the known devices now present in the prior art, the present invention, which will be described subsequently in greater detail, is to provide objects and advantages which are:

To provide for a compact generator that does not use polluting fuel such as propane or gasoline.

In order to do so, the invention consists in a non-polluting electric generator having at least one battery, an electric motor connected to the battery by electric wires, an alternator of the type used on windmills, a belt member connected between the alternator and the electric motor, and electric wires extending from the alternator adapted to connect with an electric appliance, such that the generator uses the stored energy of the battery to run the electric motor, which then runs the alternator, which then sends the desired electricity to an electric appliance.

The generator has a switch member connected in series with the at least one battery and the electric motor to thereby turn the generator on or off.

The generator has more than one battery connected together in a parallel circuit to one another.

The generator has an alternating current converter; and wherein the electric motor is a low voltage electric motor, such that the alternating current converter is connected between the at least one battery and the low voltage electric motor, and is adapted to convert direct current from the at least one battery into low voltage alternating current to power the low voltage electric motor.

The generator has a method of operation comprising the following steps:

a.) providing at least one battery;

b.) providing an electric motor connected to the at least one battery by electric wires;

c.) providing an alternator;

d.) providing a belt member connected between the alternator and the electric motor; and

e.) providing electric wires extending from the alternator adapted to connect with an electric appliance, such that the generator uses the stored energy of the at least one battery to run the electric motor, which then runs the alternator, which then sends the desired electricity to an electric appliance.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter which contains illustrated preferred embodiments of the invention.

### BRIEF DESCRIPTION OF THE DRAWINGS

FIGS. 1 Isometric see through schematic view of the invention.

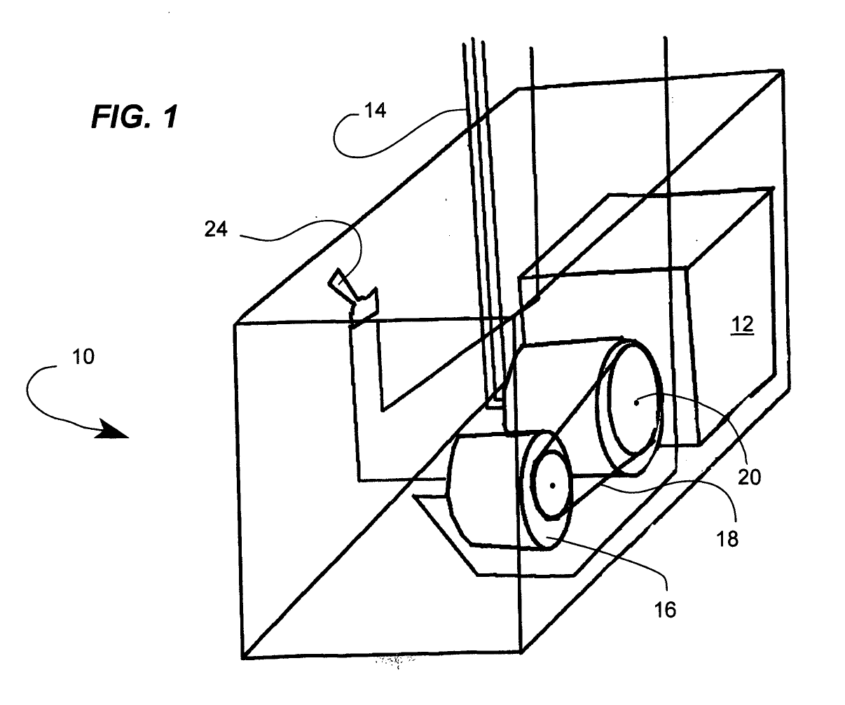

FIG. 2 Schematic top view of the invention with multiple batteries.

### DETAILED DESCRIPTION OF THE PREFERRED EMBODIMENT

A non-polluting electric generator (10) has a battery (12) which connects by wires (14) to an electric motor (16). The electric motor (16) connects by way of a belt (18) to an alternator (20).

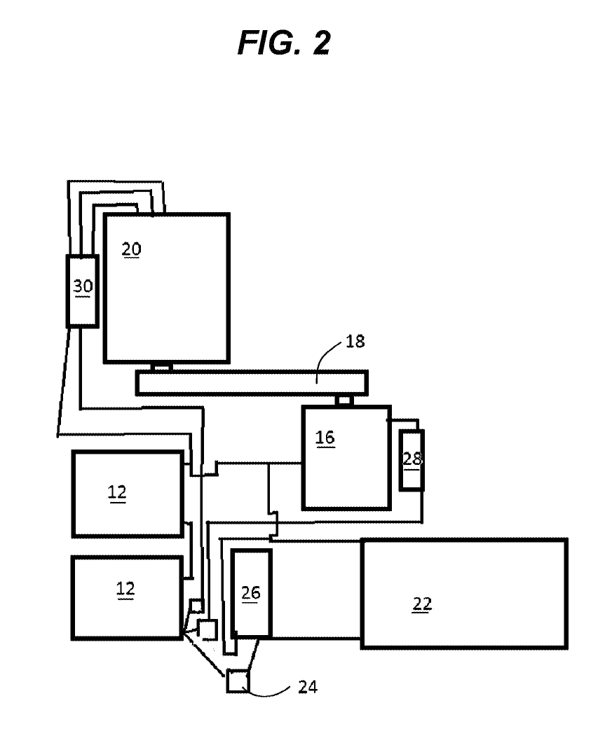

An AC converter (22) converts the DC from the battery (12) onto a 12, 24 or other low voltage AC so as to actuate the electric motor (16) operating on a compatible low voltage. Also, several batteries (12) can be connected in parallel to provide more current as seen in FIG. 2.

A switch (24) turns the generator (10) on or off. Other components such as a condenser (26), motor controller (28) and alternator controller (30) are components usually found in electrical circuits using motors or alternators and need not be further discussed herein. Fuses (not shown) are also optional components likely to be found in such circuits. The wiring is self evident as polarities have to be respected.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, punch dies are the preferred tool used but other types of cutters such as rotary drill cutters could be used and still achieve a similar result.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A non-polluting electric generator comprising at least one battery; electric motor connected to said at least one battery by electric wires; an alternator, a belt member connected between said alternator to said electric motor; and electric wires extending from said alternator adapted to connect with an electric appliance, such that said generator uses the stored energy of said at least one battery to run said electric motor, which then runs said alternator, which then sends the desired electricity to an electric appliance.

2. The non-polluting electric generator of claim 1, further comprising a switch member connected in series with said at least one battery and said electric motor to thereby turn said generator on or off.

3. The non-polluting electric generator of claim 1, wherein said at least one battery comprises a plurality of batteries connected together in a parallel circuit to one another.

4. The non-polluting electric generator of claim 1, further comprising an alternating current converter; and wherein said electric motor is a low voltage electric motor, such that said alternating current converter is connected between said at least one battery and said low voltage electric motor, and is adapted to convert direct current from said at least one battery into low voltage alternating current to power said low voltage electric motor.

5. The non-polluting electric generator of claim 4, wherein said at least one battery comprises a plurality of batteries connected together in a parallel circuit to one another.

6. A method of generating electricity comprising the following steps:
a.) providing at least one battery;
b.) providing an electric motor connected to said at least one battery by electric wires;
c.) providing an alternator,
d.) providing a belt member connected between said alternator to said electric motor, and
e.) providing electric wires extending from said alternator adapted to connect with an electric appliance, such that said generator uses the stored energy of said at least one battery to run said electric motor, which then runs said alternator, which then sends the desired electricity to an electric appliance.

7. The method of generating electricity of claim 6, further comprising the step of:
f.) providing a switch member connected in series with said at least one battery and said electric motor to thereby turn said generator on or off.

8. The method of generating electricity of claim 6, further comprising the step of:
g.) providing a plurality of batteries as said at least one battery connected together in a parallel circuit to one another.

9. The method of generating electricity of claim 6, further comprising the step of:
h.) providing an alternating current converter, and wherein said electric motor is a low voltage electric motor, such that said alternating current converter is connected between said at least one battery and said low voltage electric motor, and is adapted to convert direct current from said at least one battery into low voltage alternating current to power said low voltage electric motor.

10. The method of generating electricity of claim 9, further comprising the step of:
g.) providing a plurality of batteries as said at least one battery connected together in a parallel circuit to one another.
